(19) United States
(12) Patent Application Publication
(10) Pub. No.: US 2022/0203374 A1
(43) Pub. Date: Jun. 30, 2022

(54) HORIZONTAL SHAFT IMPACT CRUSHER SYSTEMS, METHODS AND APPARATUS

(71) Applicant: Superior Industries, Inc., Morris, MN (US)

(72) Inventors: Jared Adcock, Littleton, CO (US); Grant Holmes, Tremont, IL (US); Mike Schultz, Troutdale, OR (US); Lafe Grimm, Morris, MN (US)

(21) Appl. No.: 17/646,514

(22) Filed: Dec. 30, 2021

Related U.S. Application Data
(60) Provisional application No. 63/132,470, filed on Dec. 30, 2020.

(51) Int. Cl. B02C 13/286; B02C 13/09

(52) U.S. Cl. CPC B02C 13/286; B02C 2013/28672; B02C 2013/28627; B02C 13/095

(57) ABSTRACT

Various embodiments of horizontal shaft impact (“HSI”) crusher systems, methods and apparatus are disclosed herein. Some HSI crusher embodiments are provided an adjustable feed angle. Some HSI crusher embodiments are provided with an adjustable curtain position.

BACKGROUND

Crushers including horizontal shaft impact crushers are used to reduce the size of material such as aggregate material.

### BRIEF DESCRIPTION OF THE DRAWINGS

FIG. 1 is a left side elevation view of an embodiment of a horizontal shaft impact crusher.

FIG. 2 is a front elevation view of the horizontal shaft impact crusher of FIG. 1.

FIG. 3 is a sectional cutaway view along the section 2-2 of FIG. 2.

FIG. 4 is a sectional cutaway view of the horizontal shaft impact crusher of FIG. 1 along the section 2-2 of FIG. 2, with a curtain assembly shown in a modified configuration.

FIG. 5 is a partial enlarged view of FIG. 4.

FIG. 6 is a partial enlarged view of FIG. 4, with a feed plate in a modified configuration.

FIG. 7 is a sectional cutaway view along the section 1-1 of FIG. 1.

### DESCRIPTION

Various embodiments of horizontal shaft impact crusher (also referred to as horizontal shaft impactor) systems, methods and apparatus are disclosed herein. Some impactor embodiments are provided an adjustable feed angle. Some impactor embodiments are provided with an adjustable curtain configuration.

Some impactor embodiments include a housing having a feed opening at a lower end thereof, with the feed plate having an adjustable feed angle. Some impactor embodiments include a pivotally adjustable feed plate. Some impactor embodiments include one or more replaceable side plates configured to support the feed plate at a feed angle.

Some impactor embodiments include a housing and a curtain having an adjustable curtain configuration. Some impactor embodiments include a curtain rod removably supported on a housing of the impactor. Some impactor embodiments include a curtain having a first opening and a second opening. In some embodiments the first opening is configured to at least partially support said curtain in a first configuration of the curtain. In some embodiments the second opening is configured to at least partially support the curtain in a second configuration of said curtain. In some impactor embodiments the curtain comprises a first and second pivot and an actuator is supported on the housing. In some embodiments the actuator is coupled to said first pivot in the first configuration and the actuator is coupled to the second pivot in the second configuration.

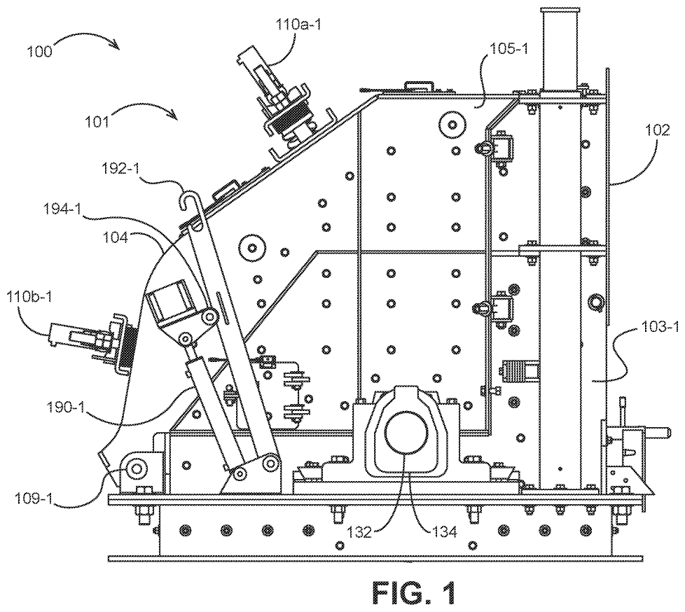

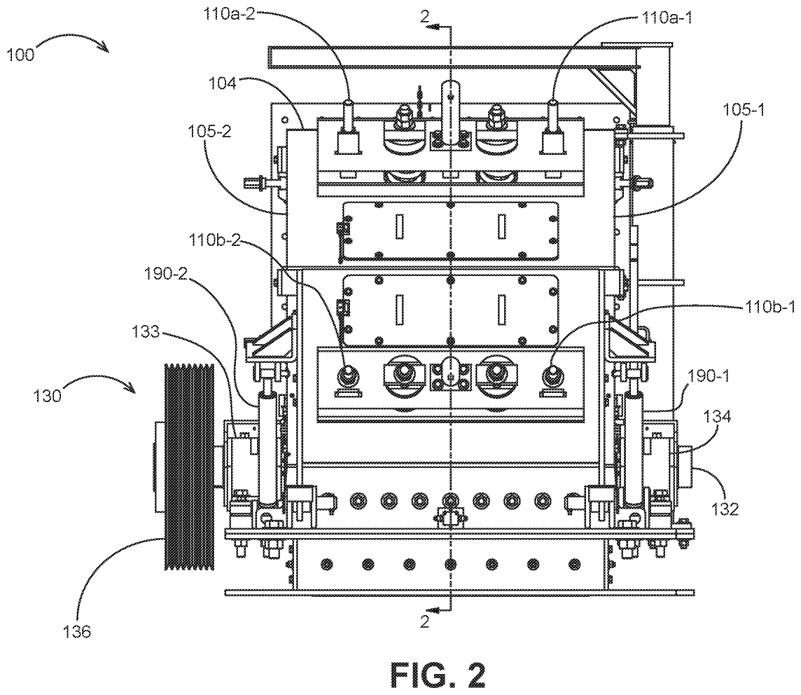

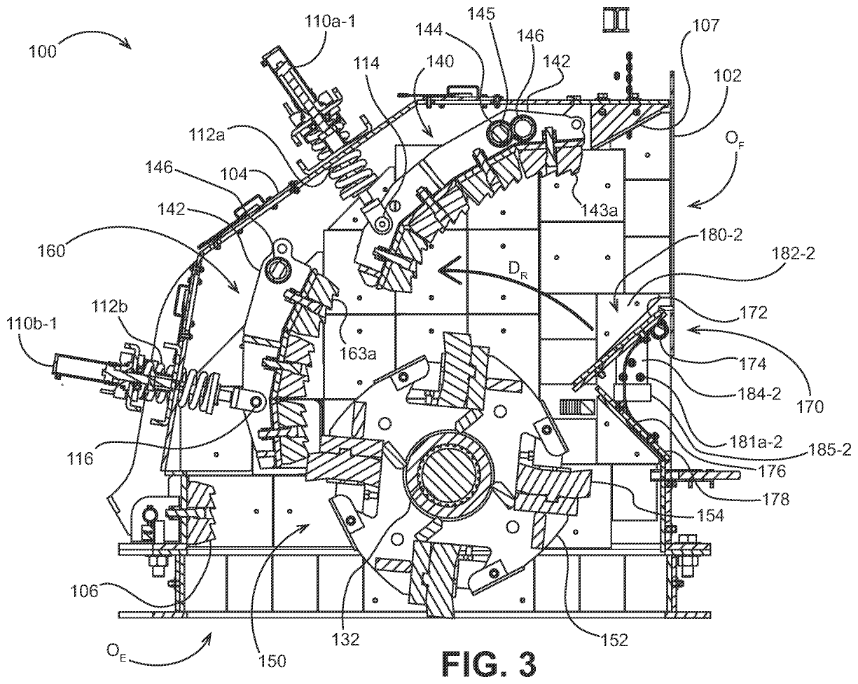

Referring to the drawings, wherein like reference numerals designate identical or corresponding parts throughout the several views, FIGS. 1 and 2 illustrate an embodiment of a horizontal shaft impactor 100. In some embodiments, impactor 100 has one or more common features or functionality with the impactor embodiments described in U.S. Pat. Nos. 6,581,862 and/or 8,967,504, both of which are hereby incorporated by reference herein in their entirety. The impactor 100 generally comprises a housing 101. The housing 101 optionally comprises a stationary portion 102 comprising sidewalls 103-1, 103-2. The housing 101 optionally comprises a movable portion 104 comprising sidewalls 105-1, 105-2. The movable portion 104 is optionally pivotable (e.g., in a generally counterclockwise direction on the view of FIG. 1) away from the stationary portion 102 about a pivot or pivots (e.g., pivots 109-1, 109-2). The movable portion 104 is optionally movable (e.g., pivotable) by an actuator or actuators (e.g., hydraulic cylinders 190-1, 190-2). The movable portion 104 is optionally supportable in a position separate from the stationary portion 102 by a support or supports (e.g., supports 192-1, 192-2) such as by locking the supports to the movable portion 104 (e.g., by locking supports 192-1, 192-2 to support bars 194-1, 194-2 provided on sidewalls 103-1, 103-2 respectively). Referring to FIG. 3, a layer 180 of removable wear plates (e.g., wear plate 182) optionally covers a portion of each sidewall of the housing 101.

Continuing to refer to FIGS. 1 and 2, a drive assembly 130 optionally comprises a shaft 132 extending laterally through the housing 101 and supported on bearings 133, 134. The shaft may be driven by any suitable device including an electric motor (not shown), which in some embodiments drives a sheave 136 via an endless belt (e.g., v-belt) or other mechanical connection.

Referring to FIG. 3, a rotor assembly 150 is optionally coupled to shaft 132 driven for rotation (e.g., about direction of rotation D_{R}) by shaft 132. The rotor assembly 150 optionally comprises a plurality of transversely-extending blow bars 154 mounted (e.g., removably mounted) to a rotor body 152 which is in turn coupled to the shaft 132. The blow bars 154 may be made of metal, e.g., a wear-resistant metal such as manganese steel. Blow bars may also be referred to as hammers. A feed opening O_{F} in the housing 101 (e.g., in the stationary portion 102) allows material (e.g., aggregate material such as rock, stone, boulders, etc.) to be fed into the housing 101 (e.g., via a conveyor, hopper, vibratory feeder, chute, etc.).

In operation of some embodiments, at least some of the material entering the feed opening O_{F} is struck by the blow bars 154 of rotor assembly 150. Material struck by the rotor optionally strikes one or more curtains (e.g., curtains 140, 160); in some cases, material is propelled by the rotor assembly 150 assembly into the curtain 140, then falls and/or bounces back onto the rotor which propels the material into the curtain 160. In some cases the material is then struck by the rotor again and/or strikes a liner 106 and/or falls downward out of an exit opening O_{E}. It should be appreciated that material is generally modified (e.g., comminuted, broken, reduced in size, crushed, etc.) by contact with the blow bars, curtains, liners, etc. It should be appreciated that individual portions or pieces of material may take different paths through the impactor 100 based on size, initial speed and orientation, shape, density, etc. Thus material may contact a subset of the components (e.g., one or more rotor blow bars, one or more curtains, liner 106, etc.) before passing through exit opening O_{E}.

The curtain 140 optionally comprises a curtain body 142 with one or more liners (e.g., transversely extending liners 143a, etc.) mounted thereto (e.g., removably mounted thereto such as by bolts or other fasteners). Curtains may also be referred to as aprons. The liners 143 are optionally made of a metal, e.g., a wear-resistant metal such as manganese steel. The curtain is optionally pivotally supported within the housing 101, e.g., on a rod 145. The rod 145 is optionally supported (e.g., removably supported) on the sidewalls (e.g. sidewalls 105-1, 105-2) of the housing 101. The rod 145 optionally extends through a laterally extending bushing 144 which extends laterally through curtain body 142. Pivotal movement of curtain 140 is optionally resiliently limited by one or more resilient supports (e.g., one or more springs 112a and/or one or more hydraulic actuators 110a). In some embodiments, each actuator 110a (e.g., a rod end thereof) is pivotally coupled to the curtain body 142 at a pivot 114 which is spaced apart from the bushing 144. Each actuator 110a is optionally supported on the housing 101 (e.g., the moveable portion thereof). It should be appreciated that extension and retraction of actuator 110a modifies the angular position of the curtain 140 about the bushing 144 (or the bushing 146 in the modified configuration described below). In some embodiments, each actuator 110a is provided with a spring 112a which is optionally disposed to absorb the impact of material striking the curtain 140 (e.g., causing generally clockwise movement of curtain 140 on the view of FIG. 3).

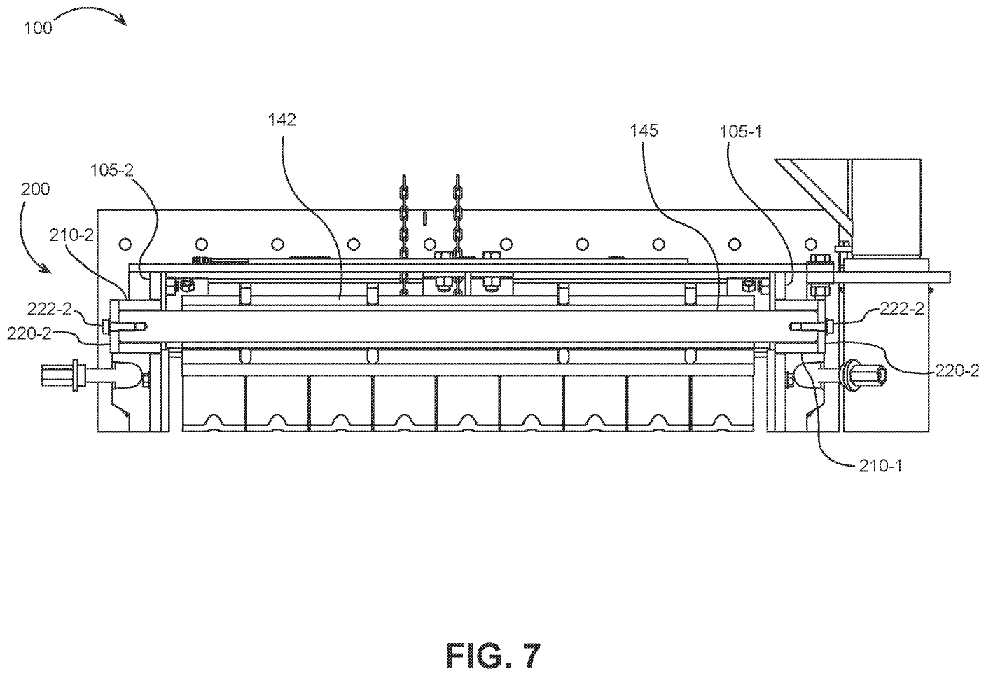

Referring to FIG. 7, the rod 145 is optionally part of a removable curtain rod assembly 200. The rod 145 is optionally inserted through openings in the sidewalls 105-1, 105-2. The rod 145 also optionally extends through bosses 210-1, 210-2 which are optionally disposed outside the housing 101. The rod 145 also optionally extends at least partially through curtain body 142. The rod 145 optionally at least partially supports (e.g., pivotally supports) curtain body 142. Once the rod 145 is inserted through the sidewalls 105 and/or bosses 210, bolts 222 are optionally used to secure caps 220 to the rod 145, thus removably securing the rod 145 in position.

Referring to FIG. 3, the curtain 160 optionally comprises a curtain body 142 with one or more liners (e.g., transversely extending liners 163a, etc.) mounted thereto (e.g., removably mounted thereto such as by bolts or other fasteners). Curtains may also be referred to as aprons. The liners 163 are optionally made of a metal, e.g., a wear-resistant metal such as manganese steel. The curtain is optionally pivotally supported within the housing 101, e.g., on a rod 165. The rod 165 is optionally supported (e.g., removably supported) on the sidewalls (e.g. sidewalls 105-1, 105-2) of the housing 101. The rod 165 optionally extends through a laterally extending bushing 146 which extends laterally through curtain body 142. Pivotal movement of curtain 164 is optionally resiliently limited by one or more resilient supports (e.g., one or more springs 112b and/or one or more hydraulic actuators 110b). In some embodiments, each actuator 110b is pivotally coupled to the curtain body 142 at a pivot 116 which is spaced apart from the bushing 146. Each actuator 110b is optionally supported on the housing 101 (e.g., the moveable portion thereof). It should be appreciated that extension and retraction of actuator 110b modifies the angular position of the curtain 160 about the bushing 146. In some embodiments, each actuator 110b is provided with a spring 112b which is optionally disposed to absorb the impact of material striking the curtain 160 (e.g., causing generally clockwise movement of curtain 160 on the view of FIG. 3).

In some embodiments liner 106 is mounted (e.g., removably mounted such as by bolts or other fasteners) to a forward wall of housing 101. The liner 106 is optionally made of a wear-resistant material such as manganese steel. The liner 106 (as well as liners 143, 163 in some embodiments) optionally comprises a serrated (i.e., jagged) surface generally oriented toward the rotor assembly 150 in order to contact aggregate material during operation.

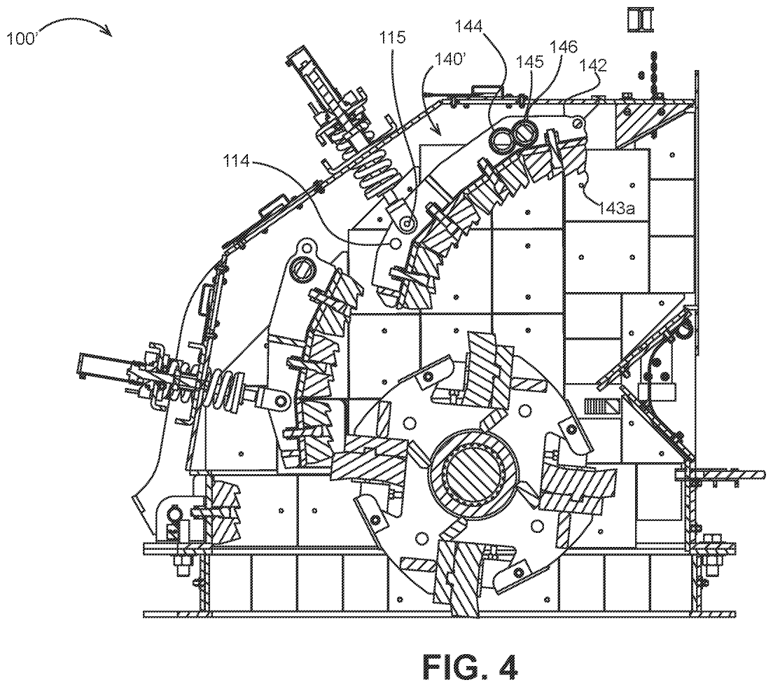

Referring to FIG. 4, in some embodiments the curtain 140 is optionally reconfigurable into a modified configuration illustrated in FIG. 4. A modified configuration of the impactor 100′ optionally has a modified configuration of curtain 140′. In some embodiments, in the modified configuration of curtain 140′ the rod 145 extends through an additional bushing 146 which is spaced apart from bushing 144. During reconfiguration, rod 145 is optionally removed (e.g., transversely) from the bushing 144 and inserted into bushing 146. In some embodiments, in the modified configuration of curtain 140′ the actuator 110a (e.g., a rod end thereof) is pivotally coupled to an additional pivot 115 spaced apart from pivot 114. It should be appreciated that the steady state position of the modified configuration of curtain 140′ is optionally closer to feed opening O_{F} than the steady state position of the configuration of curtain 140 and is optionally higher than the steady state position of the configuration of curtain 140.

It should be appreciated that in various embodiments, pivots and/or rods supporting curtains described herein may at least partially extend through a transversely extending bushing provided in a transversely extending opening in the curtain, or may at least partially extend through a transversely extending opening in the curtain with or without a separate bearing positioned in the opening.

Referring to FIG. 3, feed opening O_{F} is optionally bounded at an upper end by an upper feed plate 107 and at a lower end by a lower feed plate 172.

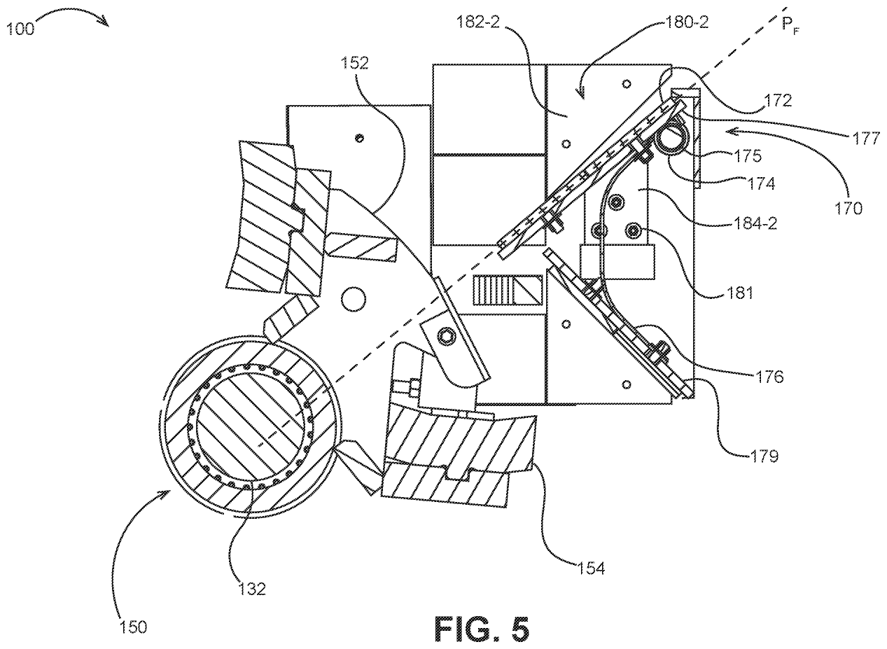

Referring to FIG. 5, the lower feed plate 172 is optionally part of a reconfigurable feed plate assembly 170. The feed plate assembly 170 is optionally pivotally supported on the housing 101. The feed plate assembly 170 is optionally at least partially supported on one or more side plates (e.g., side plates 184-1, 184-2 which may be mounted to sidewalls of the housing 101 such as by bolts 181 or other fasteners). The feed plate 172 is optionally supported on (e.g., removably mounted to such as by bolts or other fasteners) a base 177 which is optionally a plate such as a metal plate. The feed plate 172 optionally comprises a wear-resistant material such as manganese steel or other metal. The feed plate 172 is optionally pivotally supported on a transversely-extending rod 175. The rod 175 is optionally supported on the sidewalls of housing 101. The rod 175 is optionally positioned in a bushing 174. Bushing 174 is optionally mounted to the base 177. A cover 176 (e.g., a flexible cover such as a rubber flap or seal) is optionally attached (e.g., removably attached such as by bolts) to the underside of base 177 and optionally additionally attached to a lower plate 179. The cover 176 optionally prevents material from passing between the lower plate 179 and the base 177 (e.g., dust or other material from the interior of the housing 101).

Continuing to refer to FIG. 5, in some embodiments the feed plate 172 is supported by one or more side plates (e.g., side plates 184-1, 184-2) which in some embodiments are mounted to opposing sidewalls of the housing 101 (such as by bolts 181 or other fasteners). The base 177 optionally rests on an angled upper surface of the side plates 184. The angle of the upper surface of the side plates 184 optionally determines the feed plane P_{F} in which the feed plate 172 is supported on the side plates 184.

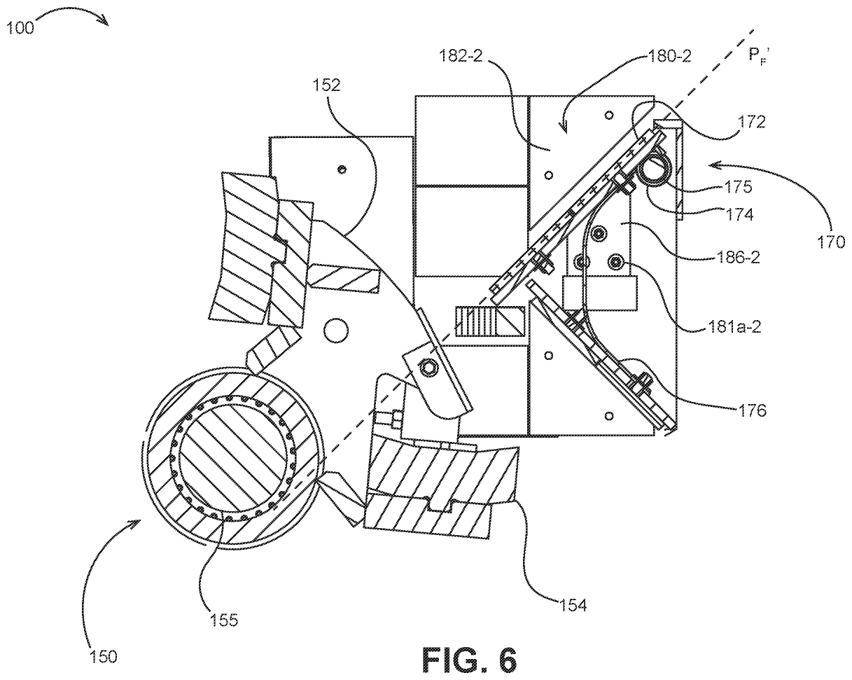

Referring to FIG. 6, the orientation of feed plate 172 is optionally adjustable to an orientation corresponding to plane P_{F}'. In some embodiments, side plates 184 are replaced with side plates 186 having a differently angled upper surface such that the feed plate 172 rests in plane P_{F}'.

The angle of planes P_{F} and P_{F}' (e.g., relative to a horizontal plane) may be referred to as the feed angle of the crusher. By adjusting position of lower feed plate 172, the feed angle of the impactor 100 is adjustable in some embodiments. In some implementations, the feed angle is modified based on the size (e.g., average size, largest size, statistical distribution of size, etc.) of material (e.g., stone, rock, etc.) entering the feed opening O_{F}. In some implementations, the feed angle may be increased (e.g., from P_{F} to P_{F}' when the size of material entering the feed opening increases). In some embodiments the feed angle may be increased manually (e.g., by replacing side plates 184 with side plates 186). In some embodiments the lower feed plate may be coupled to an actuator or other device configured to reposition the feed plate in order to modify the feed angle.

In some embodiments the lower feed plate and/or upper feed plate are optionally moveable (e.g., translatable such as vertically translatable) between a plurality of configurations in order to increase or reduce the size (e.g., height) of feed opening O_{F}. In some such embodiments the feed plate is supportable on one of a plurality of side plates (e.g., having varying heights to support the feed plate at various heights).

In various embodiments, the impactor embodiments described herein may be self-standing and/or may be incorporated in a plant having other equipment thereon (e.g., vibratory screens, vibratory feeders, hoppers, conveyors, etc.). The impactor embodiments and/or plant embodiments including such impactor embodiments may be stationary or portable (e.g., supported on skids, tracks, or wheels) according to various embodiments.

Unless otherwise indicated expressly or by the context or function of various components, the components described herein may be made of metal such as steel.

Although various embodiments have been described above, the details and features of the disclosed embodiments are not intended to be limiting, as many variations and modifications will be readily apparent to those of skill in the art. Accordingly, the scope of the present disclosure is intended to be interpreted broadly and to include all variations and modifications within the scope and spirit of the appended claims and their equivalents. For example, any feature described for one embodiment may be used in any other embodiment.

1. A horizontal shaft impactor comprising:
a housing having a feed opening O_{F}; and
a feed plate defining a lower end of said feed opening O_{F}, said feed plate having an adjustable feed angle.

2. The impactor of claim 1, wherein said feed plate is pivotally coupled to said housing.

3. The impactor of claim 2, further comprising:
a first plurality of replaceable side plates configured to be removably mounted to said housing, the first plurality of replaceable side plates configured to support said feed plate in a first plane;
a second plurality of replaceable side plates configured to be removably mounted to said housing, the second plurality of replaceable side plates configured to support said feed plate in a second plane angularly offset from said first plane.

4. The impactor of claim 1, further comprising:
a curtain, said curtain pivotally coupled to said housing in a first position for pivoting about a first horizontal axis, said curtain pivotally coupled to said housing in a second position for pivoting about a second horizontal axis offset from said first horizontal axis.

5. The impactor of claim 4, further comprising a curtain rod removably supported on said housing.

6. The impactor of claim 5, wherein said curtain comprises a first opening and a second opening, wherein said first opening is configured to at least partially support said curtain in said first position, wherein said second opening is configured to at least partially support said curtain in said second position.

7. The impactor of claim 5, further comprising: an actuator supported on said housing, wherein said curtain comprises a first and second pivot, said actuator being coupled to said first pivot in said first position, said actuator being coupled to said second pivot in said second position.

8. A horizontal shaft impactor comprising:
a housing having a feed opening O_{F};
a feed plate defining a lower end of said feed opening O_{F};
a curtain, said curtain pivotally coupled to said housing in a first position for pivoting about a first horizontal axis, said curtain pivotally coupled to said housing in a second position for pivoting about a second horizontal axis offset from said first horizontal axis; and
a curtain rod removably supported on said housing, wherein said curtain comprises a first opening and a second opening, wherein said first opening is configured to at least partially support said curtain in said first position, wherein said second opening is configured to at least partially support said curtain in said second position.

9. The impactor of claim 8, further comprising:
an actuator supported on said housing, wherein said curtain comprises a first and second pivot, said actuator being coupled to said first pivot in said first position, said actuator being coupled to said second pivot in said second position.

10. The impactor of claim 8, wherein said feed plate is pivotally coupled to said housing.

11. The impactor of claim 10, wherein said feed plate has an adjustable feed angle.

12. The impactor of claim 11, further comprising:
a first plurality of replaceable side plates configured to be removably mounted to said housing, the first plurality of replaceable side plates configured to support said feed plate in a first plane;
a second plurality of replaceable side plates configured to be removably mounted to said housing, the second plurality of replaceable side plates configured to support said feed plate in a second plane angularly offset from said first plane.

13. A horizontal shaft impactor comprising:
a housing having a feed opening O_{F}; and
a first plurality of replaceable side plates configured to be removably mounted to said housing, the first plurality of replaceable side plates configured to support said feed plate in a first plane;
a feed plate defining a lower end of said feed opening O_{F}, said feed plate being pivotally coupled to said housing.

14. The impactor of claim 13, wherein said feed plate is pivotally adjustable between at least a first position and a second position.

15. The impactor of claim 14, further comprising:
a second plurality of replaceable side plates configured to be removably mounted to said housing, the second plurality of replaceable side plates configured to support said feed plate in a second plane angularly offset from said first plane.
